(19) United States
(12) Patent Application Publication
(10) Pub. No.: US 2025/0031909 A1
(43) Pub. Date: Jan. 30, 2025

(54) VERTICALLY MOVABLE BLENDER

(71) Applicant: SECONDHOME CO., LTD., Seoul (KR)

(72) Inventor: Young Jin Kim, Goyang-si, Gyeonggi-do (KR)

(73) Assignee: SECONDHOME CO., LTD., Seoul (KR)

(21) Appl. No.: 18/729,730

(22) PCT Filed: Nov. 15, 2022
(86) PCT No.: PCT/KR2022/017976

§ 371 Date: Jul. 17, 2024

(30) Foreign Application Priority Data
Nov. 25, 2021 (KR) 10-2021-0164959

(51) Int. Cl. A47J 43/08; A47J 43/046; A47J 43/07; B01F 27/808; B01F 27/90; B01F 35/30; B01F 35/31; B01F 35/32; B01F 35/33; B01F 101/00

(52) U.S. Cl. CPC A47J 43/085; A47J 43/046; A47J 43/0722; B01F 27/808; B01F 27/90; B01F 35/31; B01F 35/3204; B01F 35/3213; B01F 35/3215; B01F 35/322; B01F 35/33; B01F 2035/351; B01F 2035/352; B01F 2101/1805

(57) ABSTRACT

The present invention provides a vertically movable blender comprising: a housing for forming the exterior thereof; a first motor which includes a first shaft having a hollow portion, and which is disposed inside the housing; a second shaft which is disposed to pass through the hollow portion of the first shaft so as to be slidable, and which rotates simultaneously with the first shaft; an actuator disposed inside the housing so as to provide driving force for sliding of the second shaft; and a clutch disposed at one end of the second shaft so as to rotate simultaneously therewith.

### TECHNICAL FIELD

The present disclosure relates to a blender with an improved structure in which a blade portion within a container may reciprocate up and down and rotate at the same time.

### BACKGROUND ART

Generally, a blender is an electric device that processes foods such as fruits, vegetables, grains, etc. by chopping, juicing, blending, cutting, or grinding them (hereinafter collectively referred to as “grinding” for convenience of explanation) so that the foods can be consumed in various forms.

Basically, a blender may include a motor housing with a built-in motor, a container that is coupled to the motor housing and has a blade that receives the rotational force of the motor and accommodates food, and a lid to open and close the top of the container.

The blade configured inside the container may be mounted on a rotating shaft of a blade assembly.

As an example of related art regarding such a blade assembly, “ROTATIONABLE SHAFT ASSEMBLY FOR A ROTATIONABLE KNIFE OF ELECTRIC MIXER” is disclosed in Korean Patent No. 10-1469100 (Announced Dec. 4, 2014). Since the above invention is well disclosed in the relevant patent document, a detailed description thereof is omitted.

However, the conventional technology as above had the following problems:

Blades for conventional blenders, including the one described above in Korean Patent No. 10-1469100, are fixed blades that simply rotate in place to grind food.

Because these conventional blenders require higher-speed rotation than necessary for grinding performance, a motor thereof is often overloaded, but technology to solve this problem has not been developed.

### DISCLOSURE

### Technical Problem

Accordingly, the present disclosure has been made keeping in mind the above problems occurring in the related art, and an objective of the present disclosure is to provide a vertically movable blender with an improved structure so that a blade may reciprocate linearly up and down.

### Technical Solution

In order to achieve the objectives described above, according to an embodiment of the present disclosure, there is provided a vertically movable blender including: a housing configured to form an exterior; a first motor configured to include a first shaft having a hollow portion, and disposed inside the housing; a second shaft disposed to pass through the hollow portion of the first shaft so as to be slidable, and configured to rotate simultaneously with the first shaft; an actuator disposed inside the housing to provide driving force for sliding of the second shaft; and a clutch disposed on a first end of the second shaft so as to rotate simultaneously therewith.

In addition, the housing may include: a seating groove recessed in an upper surface thereof; and a central hole formed in a center of the seating groove.

In addition, the central hole may be formed with a diameter corresponding to that of the clutch, and the clutch may be arranged to protrude in a direction of the seating groove.

In addition, the second shaft may be provided to have a polygonal cut surface in a direction perpendicular to a rotation axis.

In addition, the blender may further include a bushing disposed on each of upper and lower sides of the first shaft, and disposed between the first shaft and the second shaft to transmit rotational force of the first shaft to the second shaft.

In addition, the first shaft and the second shaft may be made of different materials.

In addition, the actuator may include: a second motor including a third shaft, and disposed inside the housing; and a cam disposed on the third shaft, rotating simultaneously with the third shaft, and disposed at a second end of the second shaft.

In addition, the actuator may include: a second motor including a third shaft, and disposed inside the housing; a first link having a first end thereof disposed on the third shaft so as to rotate simultaneously with the third shaft; and a second link whose first end is hinged to a second end of the first link and whose second end is hinged or in contact with the second end of the second shaft.

In addition, the blender may further include: a container that includes a partition wall dividing an upper space and a lower space of the container; and a blade portion that is rotatably placed in a container and receives rotational force and driving force for sliding from the clutch.

In addition, the blade portion may include: a fourth shaft whose lower end is attached to or detached from the clutch, and whose upper end is placed in the upper space of the container; a blade fixed to a top of the fourth shaft so as to rotate with the fourth shaft; and an elastic portion that provides restoring force to move the fourth shaft toward the housing.

### Advantageous Effects

According to the present disclosure having the above configuration, since a blade for grinding food can reciprocate linearly up and down and rotate at the same time, compared to the conventional technology (fixed rotating blade technology) in which food is ground while a blade simply rotates in place, the blending and mixing efficiency of food can be significantly improved.

Furthermore, according to the present disclosure, even at the same motor speed (rpm), food blending and mixing efficiency can be significantly improved compared to existing blenders with fixed blades, allowing food to be ground more quickly and evenly.

Furthermore, according to the present disclosure, even if the rotation speed of the blender is reduced, the same mixing effect can be maintained compared to a conventional blender equipped with fixed blades, and the noise of the blender can be reduced.

### DESCRIPTION OF DRAWINGS

FIG. 1 is a side cross-sectional view of a vertically movable blender according to an embodiment of the present disclosure.

FIG. 2 is a view illustrating a state in which a blade portion, a clutch, and a second shaft are displaced to top dead center by driving an actuator according to the first embodiment of the present disclosure.

FIG. 3 is a view illustrating a state in which a blade portion, a clutch, and a second shaft are displaced to bottom dead center by driving an actuator according to the first embodiment of the present disclosure.

FIG. 4 is a schematic view illustrating a state in which a second shaft is displaced to top dead center by driving an actuator according to the second embodiment of the present disclosure.

FIG. 5 is a schematic view illustrating a state in which a second shaft is displaced to bottom dead center by driving an actuator according to the second embodiment of the present disclosure.

### MODE FOR INVENTION

Hereinbelow, preferred embodiments of the present disclosure will be described in detail with reference to the attached drawings.

Unless otherwise specified, all terms in this specification have the same general meaning as understood by those skilled in the art, and if a term used in this specification conflicts with the general meaning of the term, the definition used in this specification shall apply.

However, the present disclosure described below is only for explaining embodiments of the present disclosure and is not intended to limit the scope of the present disclosure, and reference numbers identically used throughout the specification indicate the same elements.

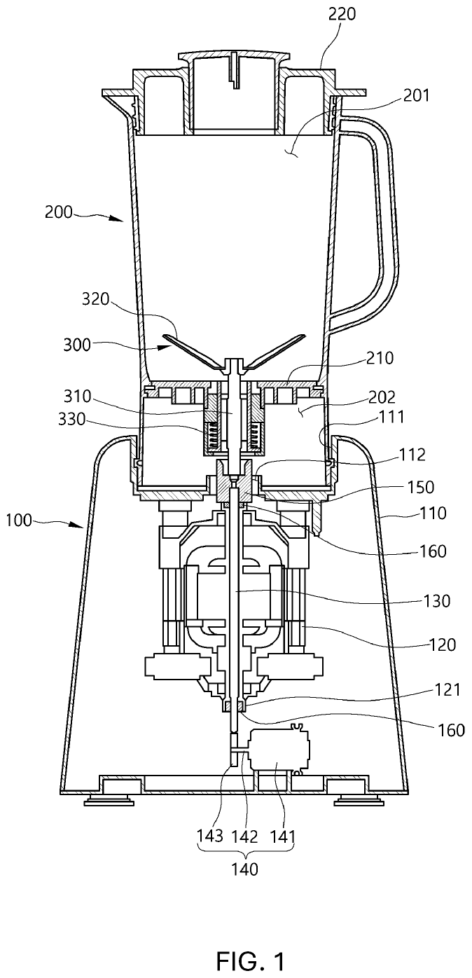

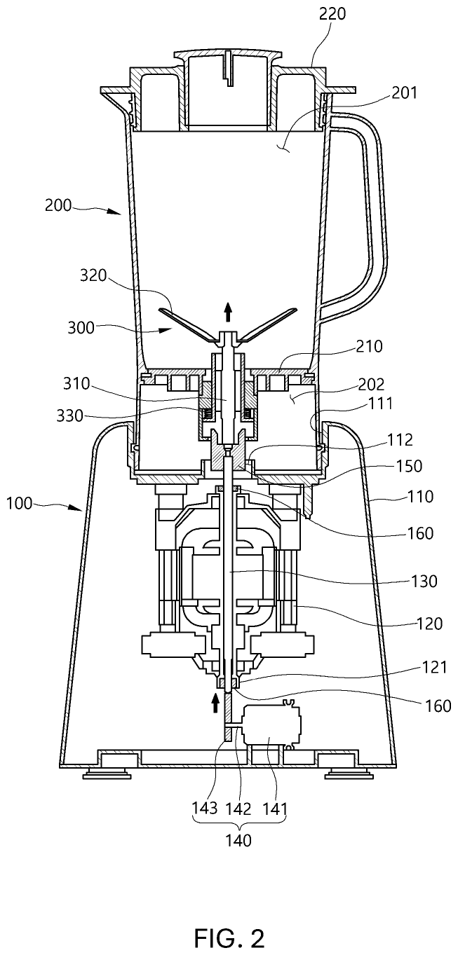

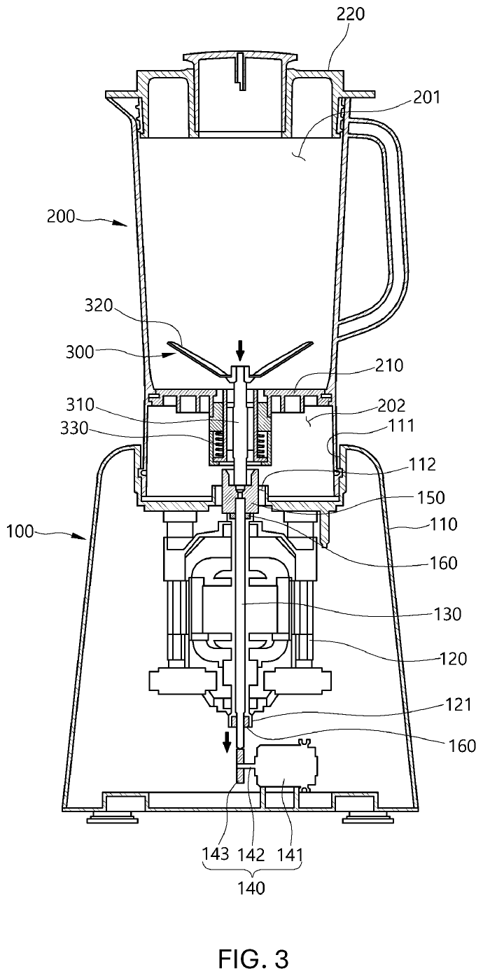

FIG. 1 is a side cross-sectional view of a vertically movable blender according to an embodiment of the present disclosure, FIG. 2 is a view illustrating a state in which a blade portion, a clutch, and a second shaft are displaced to top dead center by driving an actuator according to the first embodiment of the present disclosure, and FIG. 3 is a view illustrating a state in which a blade portion, a clutch, and a second shaft are displaced to bottom dead center by driving an actuator according to the first embodiment of the present disclosure.

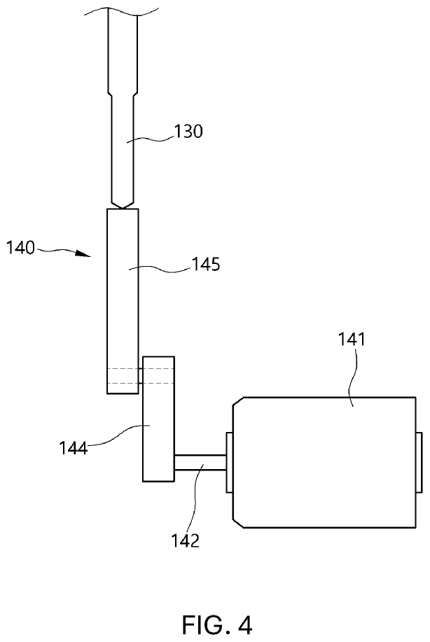

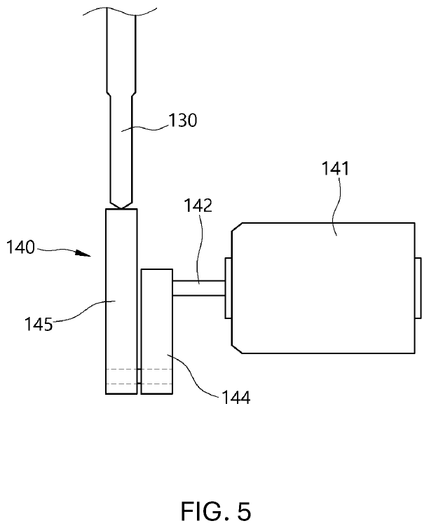

FIG. 4 is a schematic view illustrating a state in which a second shaft is displaced to top dead center by driving an actuator according to the second embodiment of the present disclosure, and FIG. 5 is a schematic view illustrating a state in which a second shaft is displaced to bottom dead center by driving an actuator according to the second embodiment of the present disclosure.

Referring to FIGS. 1 to 5, a vertically movable blender according to an embodiment of the present disclosure may largely include a main body 100, a container 200, and a blade portion 300.

The main body 100 may accommodate the container 200, and may include a housing 110, a first motor 120, a second shaft 130, an actuator 140, a clutch 150, and/or a bushing 160.

The housing 110 may form an exterior of the main body 100, and may include a seating groove 111 recessed in the upper surface thereof and a central hole 112 formed in the center of the seating groove 111.

At this time, the lower end of the container 200, which will be described later, may be placed in the seating groove 111, and the central hole 112 is formed with a diameter corresponding to that of the clutch 150, which will be described later, so that the clutch 150 may be slidably disposed.

The first motor 120 includes a first shaft 121 in which a hollow portion is formed and may be disposed inside the housing 110.

To be specific, the first motor 120 may be fixed below the bottom of the seating groove 111 so that the first shaft 121 may be located in the center of the housing 110.

The second shaft 130 may be arranged to penetrate the hollow portion of the first shaft 121 so as to be slidable and rotate simultaneously with the first shaft 121. In this case, sliding may mean movement in the direction of the rotation axis of the first shaft 121.

In addition, the second shaft 130 may be formed to have a polygonal cut surface in a direction perpendicular to the rotation axis. For example, the cut surface may have a square shape.

In this case, in order to effectively transmit the rotational force of the first shaft 121 and guide the linear movement of the second shaft 130 when sliding, the bushing 160 may be further included. The bushing 160 is disposed on each of the upper and lower sides of the first shaft 121, and is disposed between the first shaft 121 and the second shaft 130 to transmit the rotational force of the first shaft 121 to the second shaft 130.

In addition, considering the durability and sliding properties of the second shaft 130, the first shaft 121 and the second shaft 130 may be made of different materials. For example, the first shaft 121 may be made of copper, and the second shaft 130 may be made of stainless steel.

The actuator 140 may be disposed inside the housing 110 to provide driving force for sliding the second shaft 130.

Referring to FIGS. 1 to 3, the actuator 140 according to the first embodiment of the present disclosure may include: a second motor 141 including a third shaft 142 and disposed in the housing 110; and a cam 143 disposed on the third shaft 142, rotating simultaneously with the third shaft 142, and disposed at the other end of the second shaft 130.

Since the cam 143 has a roughly streamlined structure, the cam 143 may be in contact with the other end of the second shaft 130 to displace the second shaft 130 when the second shaft 130 rotates.

That is, due to the rotation of the cam 143, the second shaft 130, the clutch 150, and the blade portion 300 may be displaced to top dead center as shown in FIG. 2, and due to the rotation of the cam 143 and the restoring force of the elastic portion 330, the second shaft 130, the clutch 150, and the blade portion 300 may be displaced to bottom dead center as shown in FIG. 3.

Referring to FIGS. 4 and 5, the actuator 140 according to the second embodiment of the present disclosure may include: a second motor 141 including a third shaft 142 and disposed in the housing 110; a first link 144 having one end thereof disposed on the third shaft 142 so as to rotate simultaneously with the third shaft 142; and a second link 145 whose one end is hinged to the other end of the first link 144 and whose other end is hinged or in contact with the other end of the second shaft 130.

Due to the rotation of the first link 144, a displacement difference occurs in the second link 145, thereby displacing the second shaft 130.

The embodiment of the actuator 140 is described as having two structures, but is not limited thereto, and may include all means capable of implementing sliding of the second shaft 130.

The clutch 150 is disposed at one end of the second shaft 130 and may rotate simultaneously with the second shaft 130. A fourth shaft 310 of the blade portion 300, which will be described later, may be attached to and detached from the clutch 150.

In addition, the clutch 150 may be arranged to protrude in the direction of the seating groove 111. Between the seating groove 113 and the clutch 150, a sealing structure that may prevent foreign substances from entering the housing 110 may be further included.

The container 200 may include a partition wall 210 dividing an upper space 201 and a lower space 202. The upper space 201 may accommodate an object to be ground, and the lower space 202 may be accommodated in the seating portion of the housing 110.

In addition, the container 200 may further include a lid 220 that is openable to accommodate food in the upper space 201.

The blade portion 300 is rotatably disposed in the container 200 to receive rotational force and driving force for sliding from the clutch 150, and may include the fourth shaft 310, a blade 320, and an elastic portion 330.

The lower end of the fourth shaft 310 may be attached to or detached from the clutch 150, and the upper end of the fourth shaft 310 may be placed in the upper space of the container 200.

The blade 320 may be a single blade 320 or multiple blades 320, and may be fixed to the upper end of the fourth shaft 310 and rotated simultaneously with the fourth shaft 310.

The elastic portion 330 may provide a restoring force to move the fourth shaft 310 toward the housing 110.

For example, the elastic portion 330 may include: an elastic portion bracket disposed to surround a part of the fourth shaft 310 below the partition wall 210; and a coil spring disposed to surround the outer peripheral surface of the fourth shaft 310 inside the elastic portion bracket.

Due to the restoring force of the elastic portion 330, it is possible to prevent problems in which the fourth shaft 310 may descend at a slower speed than the clutch 150 due to ground matter and other circumstances when the fourth shaft 310 begins to descend after reaching top dead center (the highest position of sliding movement), thereby preventing the fourth shaft 310 from leaving the clutch 150.

According to the present disclosure as described above, since the movement of the second shaft 130 that receives both the rotational force of the first motor 120 shaft and the driving force for sliding of the actuator 140 is transmitted to the fourth shaft 310 of the blade portion 300 through the clutch 150, compared to the conventional technology (fixed rotating blade technology) in which food is ground while a blade simply rotates in place, the blending and mixing efficiency of food may be significantly improved.

In addition, according to the present disclosure, even at the same motor speed (rpm), food blending and mixing efficiency may be significantly improved compared to existing blenders with fixed blades, allowing food to be ground more quickly and evenly.

In addition, according to the present disclosure, even if the rotation speed of the blender is reduced, the same mixing effect may be maintained compared to a conventional blender equipped with fixed blades, and the noise of the blender may be reduced.

From the above description, those skilled in the art will be able to see that various changes and modifications can be made without departing from the technical spirit of the present disclosure, and the technical scope of the present disclosure should not be limited to the content described in the examples, but should be determined by the scope of the patent claims and their equivalents.

1. A vertically movable blender comprising:
a housing configured to form an exterior;
a first motor configured to include a first shaft having a hollow portion, and disposed inside the housing;
a second shaft disposed to pass through the hollow portion of the first shaft so as to be slidable, and configured to rotate simultaneously with the first shaft;
an actuator disposed inside the housing to provide driving force for sliding of the second shaft; and
a clutch disposed on a first end of the second shaft so as to rotate simultaneously therewith.

2. The blender of claim 1, wherein the housing comprises:
a seating groove recessed in an upper surface thereof; and
a central hole formed in a center of the seating groove.

3. The blender of claim 2, wherein the central hole is formed with a diameter corresponding to that of the clutch, and the clutch is arranged to protrude in a direction of the seating groove.

4. The blender of claim 1, wherein the second shaft is provided to have a polygonal cut surface in a direction perpendicular to a rotation axis.

5. The blender of claim 4, further comprising:
a bushing disposed on each of upper and lower sides of the first shaft, and disposed between the first shaft and the second shaft to transmit rotational force of the first shaft to the second shaft.

6. The blender of claim 1, wherein the first shaft and the second shaft are made of different materials.

7. The blender of claim 1, wherein the actuator comprises:
a second motor including a third shaft, and disposed inside the housing; and
a cam disposed on the third shaft, rotating simultaneously with the third shaft, and disposed at a second end of the second shaft.

8. The blender of claim 1, wherein the actuator comprises:
a second motor including a third shaft, and disposed inside the housing;
a first link having a first end thereof disposed on the third shaft so as to rotate simultaneously with the third shaft; and
a second link whose first end is hinged to a second end of the first link and whose second end is hinged or in contact with the second end of the second shaft.

9. The blender of claim 1, further comprising:
a container that includes a partition wall dividing an upper space and a lower space of the container; and
a blade portion that is rotatably placed in a container and receives rotational force and driving force for sliding from the clutch.

10. The blender of claim 9, wherein the blade portion comprises:
a fourth shaft whose lower end is attached to or detached from the clutch, and whose upper end is placed in the upper space of the container;
a blade fixed to a top of the fourth shaft so as to rotate with the fourth shaft; and
an clastic portion that provides restoring force to move the fourth shaft toward the housing.
